(19) United States
(12) Patent Application Publication
(10) Pub. No.: US 2010/0121842 A1
(43) Pub. Date: May 13, 2010

(54) METHOD, APPARATUS AND COMPUTER PROGRAM PRODUCT FOR PRESENTING CATEGORIZED SEARCH RESULTS

(76) Inventor: Dennis Klinkott, Munchen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/270,371

(22) Filed: Nov. 13, 2008

(51) Int. Cl. G06F 17/30; G06F 7/10

(52) U.S. Cl. 707/722; 707/E17.014

(57) ABSTRACT

An apparatus for providing for presentation of categorized search results may include a processor configured to receive search results determined responsive to a search query in which each item of the search results having an assigned category linked with at least one other category and the search results are capable of representing different types of content, select a predefined number of categories for presentation to a user, determine a display name for each selected category, and provide for presentation of the display name of each selected category in a category result area along with at least a predefined number of best matching search results corresponding to each respective selected category.

### TECHNOLOGICAL FIELD

Embodiments of the present invention relate generally to content classification technology and, more particularly, relate to an apparatus, method and a computer program product for returning search results for categorized web content, such as web pages.

### BACKGROUND

Communication networks such as the Internet or World Wide Web (“web”) may include vast amounts of information. However, locating a particular item or portion of the information can present a challenge. Moreover, with the continuous expansion of the amount of information on the web, the challenge continues to grow as well.

The information a particular user may desire to access can be obtained in a number of ways. In some cases, users may simply follow a series of known or discovered links on various web pages to desirable information that may be found on other web pages. In other cases, users may search for the information they desire by providing a search term or query to a search engine. In still other cases, the user may pose a question for which the user would like to have an answer.

Two examples of popular ways of searching for information include search engines and directories. Search engines may provide hyperlinks to web pages and to elements on web pages (e.g., images or other objects) in which a user may have interest. In some cases, search engines base their determination of the user's interest on search terms (e.g., a search query) entered by the user. In this regard, for example, the search engine may provide the user with links to high quality, relevant results based on the search query. In some cases, the search engine may accomplish this by matching the terms in the search query to a corpus of pre-stored web pages. Web pages that contain the user's search terms may be returned to the user as “hits”.

Though widely improved in the last ten years, today's search engines still use the same underlying concepts as their earlier counterparts in order to provide the user with information related to an entered search query. For example, current search engines typically provide a list of search results displayed in an ordered fashion. In this regard, for example, the search results may be ordered by general popularity of the respective website and selected if the search words occur at a prominent location on the page, such as in the title of the page. If a user is looking for information that is of interest also to an average user, these search engines may provide reasonable results. However, if a user is looking for something specific, that might be of high importance to him but not to the average user, today's search engines often do not deliver the desired result among the first 100 search results because they rank the results according to the general popularity of the website.

Furthermore, a list of search results displayed and sorted by the overall popularity of a website might lead to the desired results in cases where the search query was very specific. However, in cases where a search term is rather unspecific, the list of search results may be a mix of web pages belonging to a wide array of different topics and different semantic interpretations of the same word. The sorting criteria ‘general popularity’ may therefore not structure the display of search results in a way that would appear logical. In order to find the desired result, the user may need to either click through many pages of search results or further refine the search terms. Both of these operations may be considered tedious tasks by many users. Furthermore, success in using these approaches may depend highly on the user's imagination with respect to selection of appropriate search terms.

Other approaches to introducing further criteria have also been developed, such as clustering. Clusty.com is an example for a meta-search engine that employs clustering. Clusty.com uses words on the page to define in which cluster to put a webpage. It then displays a page including a cluster tree, which allows narrowing the search results by clicking on a cluster name in the cluster tree, and subsequently getting the results of the selected cluster displayed. While the cluster names are displayed as a cluster tree on the left part of the page, the main part of the page includes search results of all subcategories mixed together.

Clustering in this manner may not be desirable in some cases. For example, in defining clusters, reliance may be placed on evaluating words on pages that are returned as a response to the search request. Since the words on a page are only in the control of the author of the respective page, this information is not objective in any way and the quality of the assignment of web pages to clusters may be barely reliable. Additionally, clustering including only filtering the search results but not providing an ordering of the results by cluster may not be desirable in some cases. For example, if a category or a subcategory is selected, the selection may determine which search results are being displayed but may not affect in which order they are displayed. Search results on the main part of the page may be displayed as a list of search results that, although being part of a sub-cluster, are not displayed in relation to that sub-cluster, but rather are displayed as an apparently unsorted list of search results mixed across various sub-clusters.

As indicated above, directories that guide the user to popular addresses in the Internet by offering them web pages sorted by categories for an alternative to search engines. Directories are usually manually edited, which is aimed at assuring their high quality of categorization. DMOZ is an example for a directory administered under an open source license. In contrast to search engines, even big directories typically only cover a few million indexed pages which is much less than 0.1 percent of all existing web pages. While directories may provide a good logical structure to group pages in the web into categories, directories lack popularity due to the very limited amount of web pages they contain. If one is looking for something less popular but maybe important to the specific user, it may be common, or even highly likely, that the web page is not included at all in the directory and hence, the desired result may not be found.

Based on the shortcomings described above, it may be desirable to develop improved mechanisms for receiving search results for categorized web content.

### BRIEF SUMMARY

A method, apparatus and computer program product are therefore provided that may enable the presentation of categorized web content, such as web pages. In an exemplary embodiment, categorized search results may be received and presented such that only a predefined number of search results are shown for each of a predefined number of categories that have been assigned to each individual search result. As such, for example, the best search results for each of the most popular categories, or categories most likely to be interesting to the user, may be presented to the user. Thus, users may be enabled to more efficiently locate content of interest.

In an exemplary embodiment, a method of providing a presentation of categorized web content is provided. The method may include receiving search results determined responsive to a search query in which each item of the search results having an assigned category linked with at least one other category and the search results are capable of representing different types of content, selecting a predefined number of categories for presentation to a user, determining a display name for each selected category, and providing for presentation of the display name of each selected category in a category result area along with at least a predefined number of best matching search results corresponding to each respective selected category.

In another exemplary embodiment, a computer program product for providing a presentation of categorized web content is provided. The computer program product includes at least one computer-readable storage medium having computer-executable program code instructions stored therein. The computer-executable program code instructions may include program code instructions for receiving search results determined responsive to a search query in which each item of the search results having an assigned category linked with at least one other category and the search results are capable of representing different types of content, selecting a predefined number of categories for presentation to a user, determining a display name for each selected category, and providing for presentation of the display name of each selected category in a category result area along with at least a predefined number of best matching search results corresponding to each respective selected category.

In another exemplary embodiment, an apparatus for providing presentation of categorized web content is provided. The apparatus may include a processor. The processor may be configured to receive search results determined responsive to a search query in which each item of the search results having an assigned category linked with at least one other category and the search results are capable of representing different types of content, select a predefined number of categories for presentation to a user, determine a display name for each selected category, and provide for presentation of the display name of each selected category in a category result area along with at least a predefined number of best matching search results corresponding to each respective selected category.

Accordingly, embodiments of the present invention may enable improved capabilities for users to search for and locate desirable content.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system according to an exemplary embodiment of the present invention;

FIG. 2 is a schematic block diagram of an apparatus for presenting categorized search results according to an exemplary embodiment of the present invention;

FIG. 3 illustrates an example of a display showing search results presented according to an exemplary embodiment of the present invention;

FIG. 4 illustrates an example of a display showing search results including sub-categories presented according to an exemplary embodiment of the present invention;

FIG. 5 illustrates an example of a display showing search results including advertisement results presented according to an exemplary embodiment of the present invention; and

FIG. 6 is a flowchart according to an exemplary method for presenting categorized search results according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

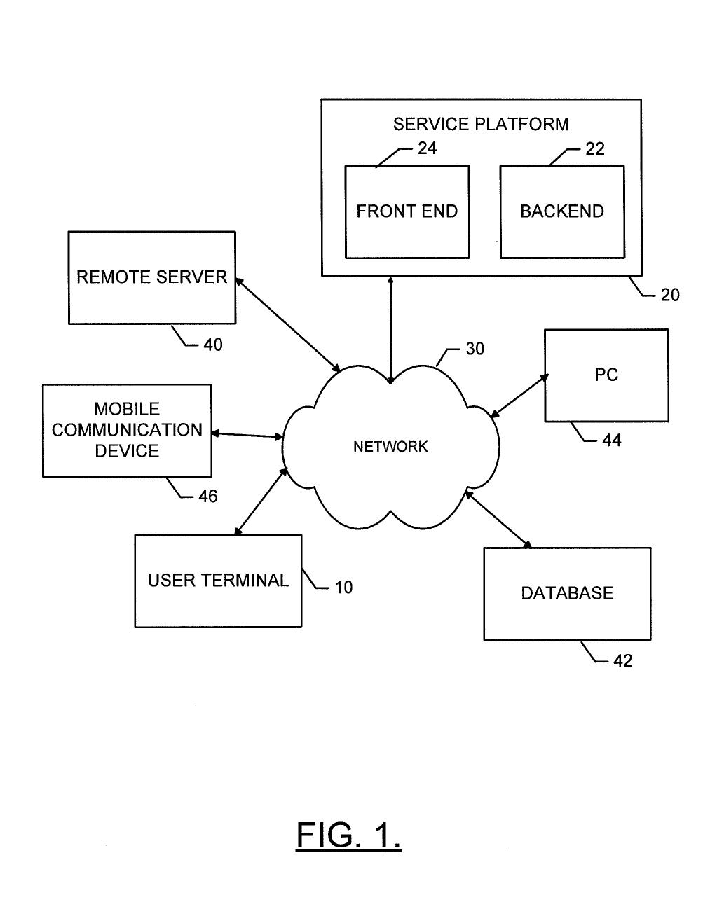

FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention. As shown in FIG. 1, an embodiment of a system in accordance with an example embodiment of the present invention may include a user terminal 10 capable of communication with numerous other devices including, for example, a service platform 20 via a network 30. In some embodiments of the present invention, the system may further include one or more additional devices such as personal computers (PCs), servers, mobile communication devices, databases, and/or the like (e.g., remote server 40, database 42, PC 44, mobile communication device 46 and others), that are capable of communication with the user terminal 10 and accessible by the service platform 20. However, not all systems that employ embodiments of the present invention may comprise all the devices illustrated and/or described herein.

The user terminal 10 may be any of multiple types of mobile or fixed communication and/or computing devices such as, for example, PCs, gaming devices, laptop computers, mobile telephones, personal digital assistants (PDAs), or any combination of the aforementioned, and/or other types of voice and text communications devices. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of wireless communication protocols. Thus, the network 30 may be a cellular network, a mobile network and/or a data network, such as a local area network (LAN), a metropolitan area network (MAN), and/or a wide area network (WAN), e.g., the Internet. In turn, other devices such as processing elements (e.g., personal computers, server computers or the like) may be included in or coupled to the network 30. By directly or indirectly connecting the user terminal 10 and the other devices (e.g., service platform 20, remote server 40, database 42, PC 44, mobile communication device 46) to the network 30, the user terminal 10 and/or the other devices may be enabled to communicate with each other, for example, according to numerous communication protocols including Hypertext Transfer Protocol (HTTP) and/or the like, to thereby carry out various communication or other functions of the user terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service (e.g., a categorization and/or search service). In this regard, for example, the service platform may include a backend 22 and a front end 24, each of which may be configured to provide data processing and/or service provision functionality in accordance with exemplary embodiments of the present invention. As such, the service platform 20 may represent a plurality of different services or information sources. Meanwhile, the backend 22 and the front end 24 may be specifically associated with corresponding functionality as described below. The functionality of the backend 22 and the front end 24 of the service platform 20 may be provided by hardware and/or software components configured to operate in accordance with embodiments of the present invention for the solicitation and/or provision of information from/to users of communication devices (e.g., the user terminal 10).

In an exemplary embodiment, the front end 24 may be configured to handle receipt of user input (e.g., a search query from the user terminal 10), processing of the search query to obtain search results and the provision of the search results to the user. As such, for example, the front end 24 may include hardware and/or software configured to receive the search query and obtain search results using a known search engine (e.g., Google, Yahoo, or any of various other search engines) in which the search results obtained are associated with categories assigned by the backend 22 in accordance with an embodiment of the present invention. The front end 24 may then be configured to provide the search results, as categorized according to categorization done by the backend 22, to the user of the user terminal 10 by any suitable mechanism. In this regard, for example, the front end 24 may be configured to calculate and present search results to the user by making use of categorization information.

The backend 22 may be configured to handle categorizing web content (e.g., web pages). In an exemplary embodiment, the backend 22 may utilize previously established or predefined categorizations to conduct categorizations of web content that has not yet been categorized. As such, for example, the backend 22 may compare information about particular web content (e.g., a web page that has not yet been categorized) to information about other web content (e.g., web pages that have been previously categorized) in order to determine with which category the particular web page should be associated. The backend 22 may also (or alternatively) incorporate other information into determinations regarding categorization of the particular web content. For example, categorizations may be performed on the basis of determining which categories the particular web page links to and assigning a category that matches or is otherwise determinable from the categories assigned to the web pages linked to by the particular web page. As an alternative, the backend 22 may examine the web pages from which the particular web page is liked and assign a category to the particular web page based on the categories of any pages that themselves link to the particular web page. In an exemplary embodiment, the backend 22 may be configured to examine web content accessible throughout the network 30. As such, the backend 22 may categorize content accessible from any of the devices in communication with the network 30 (e.g., remote server 40, database 42, PC 44, mobile communication device 46 and many others). Alternative mechanisms for categorizing web content may also be employed by the backend 22.

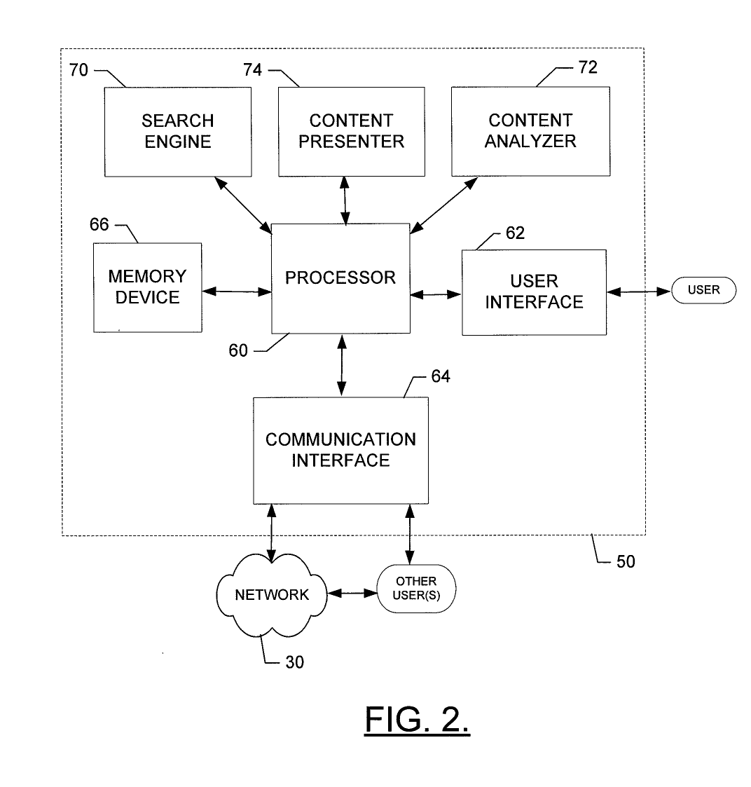

FIG. 2 illustrates a schematic block diagram of an apparatus for providing search results for categorized web content according to an exemplary embodiment of the present invention. An exemplary embodiment of the invention will now be described with reference to FIG. 2, in which certain elements of an apparatus 50 for providing search results for categorized web content are displayed. The apparatus 50 of FIG. 2 may be employed, for example, on the service platform 20, and more specifically on the front end 24, of FIG. 1. However, the apparatus 50 may alternatively be embodied at a variety of other devices. As such, in some cases, embodiments may be employed on a combination of devices (e.g., in a distributed fashion or in a client/server relationship). Furthermore, it should be noted that the devices or elements described below may not be mandatory and thus some may be omitted in certain embodiments.

Referring now to FIG. 2, an apparatus for providing search results for categorized web content is provided. The apparatus 50 may include or otherwise be in communication with a processor 60, a user interface 62, a communication interface 64 and a memory device 66. The memory device 66 may include, for example, volatile and/or non-volatile memory. The memory device 66 may be configured to store information, data, applications, instructions and/or the like. For example, the memory device 66 could be configured to buffer input data for processing by the processor 60. Additionally or alternatively, the memory device 66 could be configured to store instructions for execution by the processor 60. As yet another alternative, the memory device 66 may be one of a plurality of databases that store information and/or web or media content.

The processor 60 may be embodied in a number of different ways. For example, the processor 60 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 60 may be configured to execute instructions stored in the memory device 66 or otherwise accessible to the processor 60. In some embodiments, the processor 60 (and/or the user interface 62, the communication interface 64 and the memory device 66) of the apparatus 50 may be shared between the front end 24 and the backend 22. However, in other embodiments, some or all of such devices or components may be replicated or separately embodied at each of the front end 24 and backend 22.

The communication interface 64 may be any means such as a device or circuitry embodied in either hardware, software, or a combination of hardware and software that is configured to receive and/or transmit data from/to a network (e.g., the network 30) and/or any other device or module in communication with the apparatus 50. In this regard, the communication interface 64 may include, for example, an antenna (or multiple antennas) and supporting hardware and/or software for enabling communications with a wireless communication network. In fixed environments, the communication interface 64 may alternatively or also support wired communication. As such, the communication interface 64 may include a communication modem and/or other hardware/software for supporting communication via cable, digital subscriber line (DSL), universal serial bus (USB), Ethernet or other mechanisms.

The user interface 62 may be in communication with the processor 60 to receive an indication of a user input at the user interface 62 and/or to provide an audible, visual, mechanical or other output to the user. As such, the user interface 62 may include, for example, a keyboard, a mouse, a joystick, a display, a touch screen, a microphone, a speaker, or other input/output mechanisms. In an exemplary embodiment in which the apparatus 50 is embodied as a server or some other network devices, the user interface 62 may be limited, or even eliminated.

In an exemplary embodiment, the processor 60 may be embodied as, include or otherwise control a search engine 70, a content analyzer 72 and a content presenter 74. As such, the search engine 70, the content analyzer 72 and the content presenter 74 may in some cases each be separate devices, modules, or functional elements. However, in other embodiments, some or all of the search engine 70, the content analyzer 72 and the content presenter 74 may be embodied within a single device, module, or functional element, such as the processor 60. Moreover, in some cases, the search engine 70 may be separate from the apparatus 50 and may provide search results to the apparatus 50.

The search engine 70, the content analyzer 72 and the content presenter 74 may each be any means such as a device or circuitry embodied in hardware, software or a combination of hardware and software (e.g., processor 60 operating under software control) that is configured to perform the corresponding functions of the search engine 70, the content analyzer 72 and the content presenter 74, respectively, as described below. Accordingly, the search engine 70, the content analyzer 72 and the content presenter 74 may each be specific functional components configured to perform processing as defined herein of specific data (e.g., web pages and/or other web content) in order to enable presentation of categorized web content. In some embodiments, communication between the search engine 70, the content analyzer 72 and the content presenter 74 may be conducted via the processor 60. However, the search engine 70, the content analyzer 72 and the content presenter 74 may alternatively be in direct communication with each other.

Embodiments of the present invention may utilize a database that contains categorization information for each item of web content (e.g., each web page) within the network 30 (e.g., the Internet). Accordingly, for search results received (e.g., from the search engine 70), some embodiments of the present invention may be enabled to determine a category associated with each of the search results and present selected ones of the results within their respective categories based on popularity of the results. As an example, web pages may be categorized by the backend 22 and when search results are received in response to a search conducted for a search query entered at the front end 24, the received search results may be associated with their respective categories. Search result categories may then be presented to the user with a predefined number of the most popular results being presented in each category. Furthermore, the categories may be ranked based on the popularity of the results associated with each category and a predetermined number of the highest ranked categories may be presented to the user. As such, in some embodiments, the availability of categorization information for all web pages may be a prerequisite for employing (or optimally employing) embodiments of the present invention.

The search engine 70 may be any means such as a device or circuitry configured to receive a search term identification (e.g., from the user interface 62 or from the network 30 via the communication interface 64) and search various accessible sources (e.g., databases and or memory resources associated with any of the remote server 40, the database 42, the PC 44, the mobile communication device 46 and others) for information associated with the search term identification. In response to a search associated with the search term, the search engine 70 may be configured to identify and/or provide content items associated with the search term. For example, the search engine 70 may be similar to or incorporate the search concepts and strategies employed in conjunction with familiar search engines such as Yahoo, Google, Cuil, Clusty.com or many others. In some embodiments, the search engine 70 may rank search results according to importance based on any of a number of criteria (e.g., the number of pages that reference the ranked page, the number of hits to the ranked page, a relevance score, or other mechanisms). Thus, an output of the search engine 70 may include an identification of web content (e.g., web pages) that are associated with the search term, and are also significant, important and/or popular.

The content analyzer 72 may then analyze the search results. In this regard, for example, the content analyzer 72 may determine a category associated with or linked to each of the search results. In this regard, for example, the content analyzer 72 may communicate with or otherwise consult the backend 22 or another source of information including an indication of the categories associated with each respective web page of the search results. In some cases, the content analyzer 72 may actually only investigate the categories of a predetermined number of the highest ranked search results. As yet another alternative, the content analyzer 72 may determine the categories of a number of search results sufficient to include a predetermined number of results in each of a predetermined number of categories. Thus, for example, if two search results for each of five categories is desired, the content analyzer 72 may examine the ranked search results to determine the category of each of the top ranked results in order until at least two items in at least five categories have been encountered. Additionally or alternatively, the content analyzer 72 may be configured to select categories determined to be the most popular (e.g., based on the popularity of the search results associated therewith) and/or having the highest number of ranked pages, until a predetermined number of categories have been selected.

In some embodiments, the content analyzer 72 may also assign names to the categories (if names are not already assigned). In this regard, the names assigned to the categories may match the names of the categories themselves as they are stored in the backend 22. However, as an alternative, the content analyzer 72 may assign other names to the categories. The results of the processing performed by the content analyzer 72 may then be communicated to the content presenter 74.

The content presenter 74 may be configured to communicate with the user interface 62 and/or the network 30 via the communication interface 64 in order to provide information for display at the user's display. The information provided for display may drive the corresponding display to illustrate the search results presented according to embodiments of the present invention. For example, the content presenter 74 may receive information (e.g., from the content analyzer 72) that is indicative of the categories in which search results were received and content items or results associated with each category. The content presenter 74 may then be configured to select a predefined number of categories with a corresponding predefined number of content items in each respective category. Finally, the content presenter 74 may provide for or enable presentation of the selected categories and items at the user's display. The content presenter 74 may arrange the information to be presented so that, for example, the category relating to the most popular search result content item may be listed first, on top or most prominently and subsequent categories may also be presented in order of popularity. Alternatively, the category having the largest number of search results therein may be listed first, on top or most prominently and subsequent categories may be presented in order of the respective number of search results in each category.

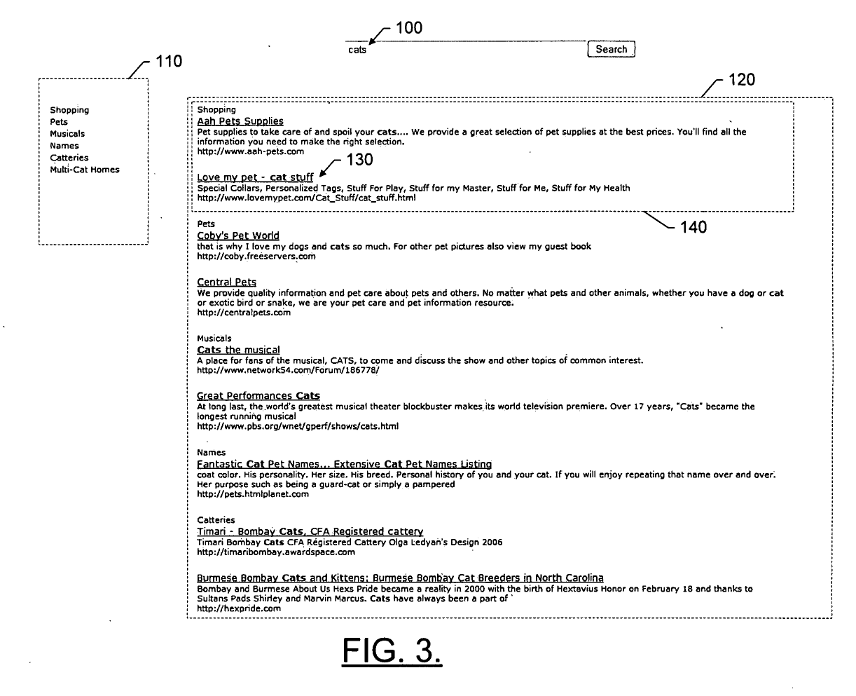

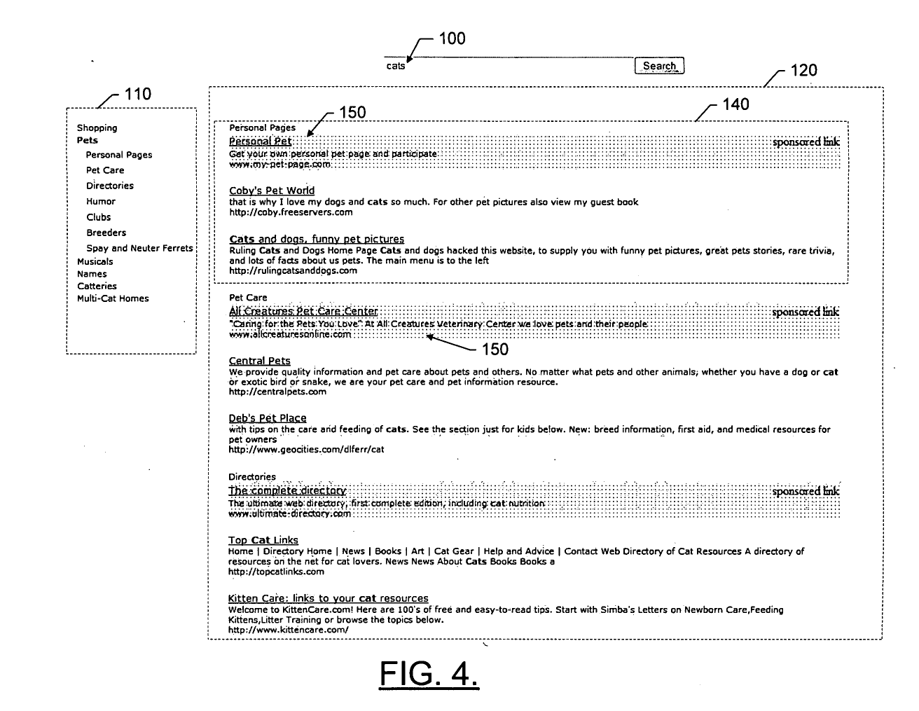

In an exemplary embodiment, the content presenter 74 may arrange a search result page according to the examples shown in FIGS. 3 and 4. In this regard, as shown in FIG. 3, a search term 100 (or query) may be entered into a search field. Search results may be received from a search engine as described above and categorized. As indicated in FIG. 3, the content presenter 74 may provide a list of categories section 110 and a search result section 120. The list of categories section 110 may include a listing of all (or a predefined number of the highest ranked) categories associated with the search results. The search results in the search result section 120 may be arranged by category such that a predetermined number of the top results (e.g., most popular in terms of hits or links) in each category are displayed.

In the example of FIG. 3, the category “Shopping” may have the most popular results therein and the category “Pets” may have the second most popular results for a search related to the search term 100 of “cats”. Accordingly, in the category section 110, the categories are listed from top to bottom in order with the categories that provide the most popular results near the top of the list. Similarly, under each category displayed in the result section, the top two most popular results are shown. Thus, for example, within the category “pets”, the most popular search result is a web page titled “Coby's Pet World” and the second most popular search result for this category is a web page titled “Central Pets”. Based on this example, the most popular search result of all may be assumed to be the search result item entitled “Aah Pets Supplies”, which is located under the “Shopping” category.

In response to selection of one of the categories (either from the list in the category section 110 or the search result section 120) subcategories under the selected category may be revealed as shown in the category section 110 of FIG. 4. In this regard, in response to selection of the “Pets” category, subcategories under the “Pets” category may be displayed in the category section 110. Furthermore, a predefined number of the most popular subcategories associated with the “Pets” category may also be displayed in the search result section 120. The top two search results in each subcategory may also be displayed in association with (e.g., under and proximate to) the respective subcategory. As indicated above, the subcategories may be displayed in rank order. Thus, for example, since the web page titled “Coby's Pet World” was most popular, its respective subcategory “Personal Pages” may be displayed at the top of the list of subcategories. Meanwhile, since the second most popular search result for this category was the web page titled “Central Pets”, its respective category “Pet Care” may be displayed second in the listing of subcategories. Selection of a subcategory may link to a further listing of sub-subcategories at a next more specific or lower hierarchical level (if applicable). Selection of a search result (e.g., page 130) may link to the corresponding page.

Thus, according to an exemplary embodiment, an initial search result list is created with each search result being linked to a category. Then from the set of categories, a subset of categories may be selected that will be displayed. For each selected category, a display name may be created. The search results belonging to the selected categories may then be displayed subdivided by categories. Accordingly, for each selected category a category result area 140 (e.g., within the search result section 120) may be defined for each category that includes a display name for the category and up to n search results belonging to the corresponding category. The category result areas 140 may be displayed one below the other.

In each category result area 140, the category display name may be a selectable element that allows the user to select the category. If the user selects a category, the search input field defining the search term 100 may remain unmodified, but the search result list in the search result section 120 may be changed to include only categories selected that represent subcategories of the user selected category. As such, only search results displayed that are categorized as subcategories of the user selected category may be provided.

The category display names may be determined depending on the search request in order to provide the most meaningful information. In some embodiments, category display names may be determined in such a way that any information that is displayed provides additional information. In other words, a category display name may be chosen so that the selected display name is not redundant in relation to the search query, or any other category display name. For example, in one exemplary embodiment of the present invention, displayed category names are calculated in a way that guarantees that none of the search words occurs in the category name. For example, if a user searches for “car”, a category of “car magazines” may simply be listed as “magazines”, since adding the term “car” to the category name would not provide any additional useful information to the user. As an alternative, a potential display name may be checked to ensure that the display name is not used in its corresponding parent category display name. As yet another alternative, a potential display name may be checked to provide that the display name is not used for another subcategory in the same category. Display name determinations may, in some cases, select a most general category description possible and, if any of the checks above fail, select a more specific category description. As an example, if two hits are received including one hit having related categories of “online-shops/book-stores/used-books” and another hit with related categories of “fashion/clothes/designer”, display names selected may include “online-shops” for the first hit and “fashion” for the second hit since there are no conflicts and the most general category can therefore be selected. However, in an example where a first hit has related categories of “online-shops/book-stores/used-books” and a second hit has related categories of “online-shops/clothes/designer”, the category names displayed may be “book-stores” and “clothes”, respectively, since there is a conflict for “online-shops” and thus a more specific category description is chosen.

In an exemplary embodiment, the content presenter 74 may be further configured to include at least one advertisement result (e.g., advertisement result 150) in the category result area 140 of one or more of the categories. In this regard, for example, the advertisement result may be a link to a product or service advertisement that is related to the corresponding category. In some cases, a business associated with the product or service advertisement may purchase the right to be included in search results for a particular category. In some cases, the advertisement result may be displayed having different characteristics than other search results. For example, the advertisement result may have different shading, a different font size or type, an icon, or other distinguishing characteristics relative to the search results associated therewith. In some embodiments, only certain ones of the category result areas corresponding to the categories displayed (e.g., categories for which a particular sponsor or business has purchased advertising rights) may include advertisement results. Moreover, in some situations, the content presenter 74 may be configured to limit the number of category result areas that may include advertisement results (e.g., only the top two or three category result areas may include advertisement results.

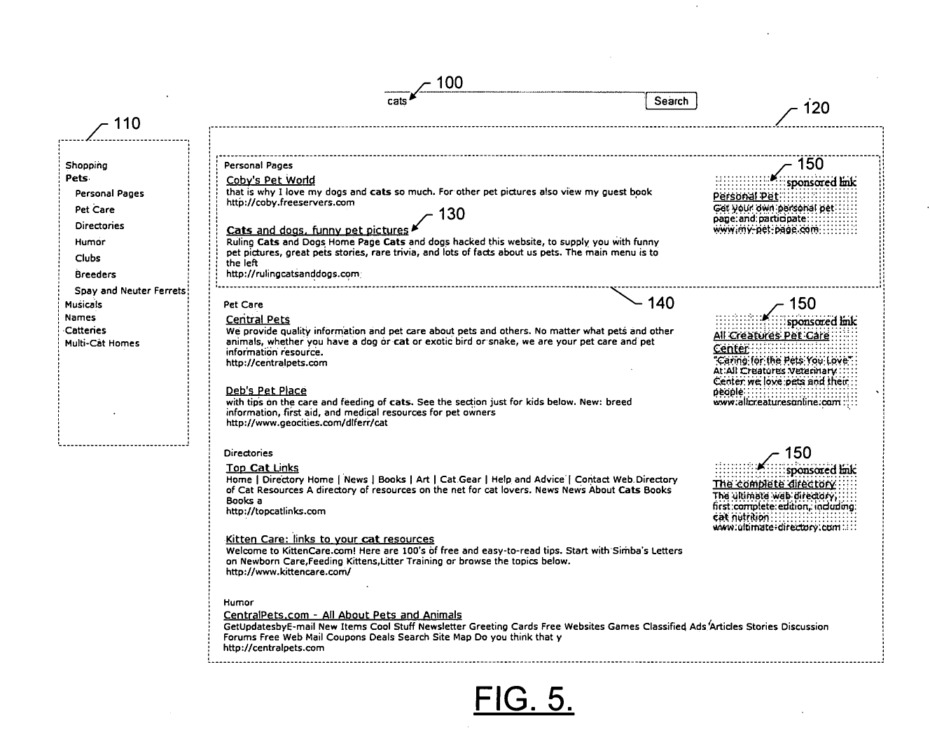

In an exemplary embodiment, a special icon or other indication of corresponding advertisement results for a particular category may be presented in association with the particular category. In response to selection of the icon or indication, a listing of advertisement results associated with the particular category may be provided. The special icon or other indication may be included along with a single top advertisement result or may be provided instead of including advertisement results in the category result area 140 as a mechanism by which advertisement information may be accessed if desired. In some cases, the user may be given an option (e.g., via preferences or user settings) as to whether search results may include advertisement results and/or by what manner such results are to be provided. Although the advertisement result 150 could be presented among the search results in the category result area 140 as indicated in FIG. 4, alternative options for display may also be employed. In this regard, FIG. 5 shows an example of displayed search results in which at least one category result area 140 includes the advertisement result 150 displayed in an alternative position (e.g., to the right of the search results).

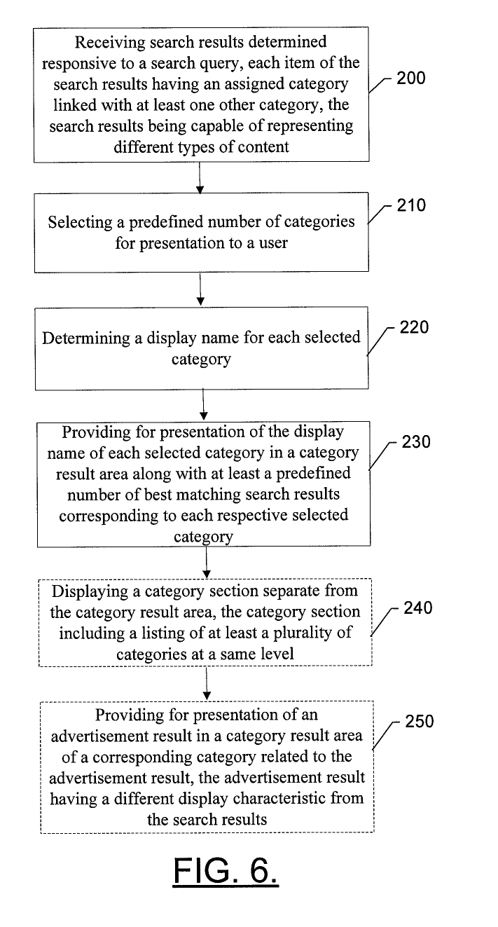

FIG. 6 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device (e.g., of the front end 24) and executed by a built-in processor (e.g., the processor 60). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing a presentation of categorized search results as provided in FIG. 6 may include receiving search results determined responsive to a search query at operation 200. Each item of the search results may have an assigned category linked with at least one other category. In some cases, the search results may be capable of representing different types of content. The method may further include selecting a predefined number of categories for presentation to a user at operation 210 and determining a display name for each selected category at operation 220. In an exemplary embodiment, the method may further include providing for presentation of the display name of each selected category in a category result area along with at least a predefined number of best matching (e.g., most popular) search results corresponding to each respective selected category at operation 230. Of note, the ordering of the operations provided in FIG. 6 is not necessarily fixed. Thus, some of the operations of FIG. 6 may be performed in a different order to achieve the same result and the order in which such operations appear in FIG. 6 should not be taken as a limiting factor.

In some embodiments, the method may include further optional operations, some examples of which are shown in dashed lines in FIG. 6. Optional operations may be performed in any order and/or in combination with each other in various alternative embodiments. As such, the method may further include operations of displaying a category section separate from the category result area, the category section including a listing of at least a plurality of categories at a same level at operation 240 and/or providing for presentation of an advertisement result in a category result area of a corresponding category related to the advertisement result at operation 250. The advertisement result may include a different display characteristic from the search results.

In some embodiments, certain ones of the operations above may be modified or further amplified as described below. It should be appreciated that each of the modifications or amplifications below may be included with the operations above either alone or in combination with any others among the features described herein. In this regard, for example, displaying the category section may include providing for expansion of sub-categories at a different (e.g., more specific or more general) level associated with one of the categories of the category section in response to user selection of the one of the categories. In some cases, providing for presentation of the display name may include providing for a user selectable element including the display name. The user selectable element may provide, in response to selection of the user selectable element, for presentation of related (e.g., hierarchically related) search results to the category in the category result area associated with the user selectable element.

In some cases, providing for presentation of the display name may include providing for presentation of the predefined number of categories in rank order according to which categories have most popular search results. Alternatively or additionally, providing for presentation of the display name may include providing for presentation of the predefined number of categories in rank order according to which categories have a highest number of search results.

In one exemplary embodiment, a method of providing categorized search results along with corresponding advertisements may include only operations 200, 230 and 250, although additional operations could also be included in some cases.

In an exemplary embodiment, an apparatus for performing the method of FIG. 6 above may comprise a processor (e.g., the processor 60) configured to perform some or each of the operations (200-250) described above. The processor may, for example, be configured to perform the operations (200-250) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-250 may comprise, for example, the processor 60, the search engine 70, the content analyzer 72 and the content presenter 74, and/or an algorithm executed by the processor 60 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving search results determined responsive to a search query, each item of the search results having an assigned category linked with at least one other category, the search results being capable of representing different types of content;
selecting a predefined number of categories for presentation to a user;
determining a display name for each selected category; and
providing for presentation of the display name of each selected category in a category result area along with at least a predefined number of best matching search results corresponding to each respective selected category.

2. The method of claim 1, further comprising displaying a category section separate from the category result area, the category section including a listing of at least a plurality of categories at a same level.

3. The method of claim 2, wherein displaying the category section further comprises providing for expansion of categories at a different level associated with one of the categories of the category section in response to user selection of the one of the categories.

4. The method of claim 1, wherein providing for presentation of the display name comprises providing for a user selectable element including the display name, the user selectable element providing, in response to selection of the user selectable element, for presentation of related search results to the category in the category result area associated with the user selectable element.

5. The method of claim 1, further comprising providing for presentation of an advertisement result in a category result area of a corresponding category related to the advertisement result.

6. The method of claim 1, wherein providing for presentation of the display name comprises providing for presentation of the predefined number of categories in rank order according to which categories have most popular search results.

7. The method of claim 1, wherein providing for presentation of the display name comprises providing for presentation of the predefined number of categories in rank order according to which categories have a highest number of search results.

8. The method of claim 1, wherein determining the display name comprises selecting a category display name that lacks redundant terms in relation to the search query or any other category display name of a different or same level.

9. A computer program product comprising at least one computer-readable storage medium having computer-executable program code instructions stored therein, the computer-executable program code instruction comprising:
program code instructions for receiving search results determined responsive to a search query, each item of the search results having an assigned category linked with at least one other category, the search results being capable of representing different types of content;
program code instructions for selecting a predefined number of categories for presentation to a user;
program code instructions for determining a display name for each selected category; and
program code instructions for providing for presentation of the display name of each selected category in a category result area along with at least a predefined number of best matching search results corresponding to each respective selected category.

10. The computer program product of claim 9, further comprising program code instructions for displaying a category section separate from the category result area, the category section including a listing of at least a plurality of categories at a same level.

11. The computer program product of claim 10, wherein program code instructions for displaying the category section further include instructions for providing for expansion of categories at a different level associated with one of the categories of the category section in response to user selection of the one of the categories.

12. The computer program product of claim 9, wherein program code instructions for providing for presentation of the display name include instructions for providing for a user selectable element including the display name, the user selectable element providing, in response to selection of the user selectable element, for presentation of related search results to the category in the category result area associated with the user selectable element.

13. The computer program product of claim 9, further comprising program code instructions for providing for presentation of an advertisement result in a category result area of a corresponding category related to the advertisement result.

14. The computer program product of claim 9, wherein program code instructions for providing for presentation of the display name include instructions for providing for presentation of the predefined number of categories in rank order according to which categories have most popular search results.

15. The computer program product of claim 9, wherein program code instructions for providing for presentation of the display name include instructions for providing for presentation of the predefined number of categories in rank order according to which categories have a highest number of search results.

16. The computer program product of claim 9, wherein program code instructions for determining the display name include instructions for selecting a category display name that lacks redundant terms in relation to the search query or any other category display name of a different or same level.

17. An apparatus comprising a processor configured to:
receive search results determined responsive to a search query, each item of the search results having an assigned category linked with at least one other category, the search results being capable of representing different types of content;
select a predefined number of categories for presentation to a user;
determine a display name for each selected category; and
provide for presentation of the display name of each selected category in a category result area along with at least a predefined number of best matching search results corresponding to each respective selected category.

18. The apparatus of claim 17, wherein the processor is further configured to display a category section separate from the category result area, the category section including a listing of at least a plurality of categories at a same level.

19. The apparatus of claim 18, wherein the processor is configured to display the category section further by providing for expansion of categories at a different level associated with one of the categories of the category section in response to user selection of the one of the categories.

20. The apparatus of claim 17, wherein the processor is configured to provide for presentation of the display name by providing for a user selectable element including the display name, the user selectable element providing, in response to selection of the user selectable element, for presentation of related search results to the category in the category result area associated with the user selectable element.

21. The apparatus of claim 17, wherein the processor is further configured to provide for presentation of an advertisement result in a category result area of a corresponding category related to the advertisement result.

22. The apparatus of claim 17, wherein the processor is configured to provide for presentation of the display name by providing for presentation of the predefined number of categories in rank order according to which categories have most popular search results.

23. The apparatus of claim 17, wherein the processor is configured to provide for presentation of the display name by providing for presentation of the predefined number of categories in rank order according to which categories have a highest number of search results.

24. The apparatus of claim 17, wherein the processor is configured to determine the display name by selecting a category display name that lacks redundant terms in relation to the search query or any other category display name of a different or same level.

25. A method comprising:
receiving search results determined responsive to a search query, each item of the search results having an assigned category linked with at least one other category, the search results being capable of representing different types of content;
providing for presentation of selected ones of the search results associated with corresponding selected categories in respective category result areas; and
providing for presentation of an advertisement result in a category result area of a corresponding category related to the advertisement result.

26. A computer program product comprising at least one computer-readable storage medium having computer-executable program code instructions stored therein, the computer-executable program code instruction comprising:
program code instructions for receiving search results determined responsive to a search query, each item of the search results having an assigned category linked with at least one other category, the search results being capable of representing different types of content;
program code instructions for providing for presentation of selected ones of the search results associated with corresponding selected categories in respective category result areas; and
program code instructions for providing for presentation of an advertisement result in a category result area of a corresponding category related to the advertisement result.

27. An apparatus comprising a processor configured to:
receive search results determined responsive to a search query, each item of the search results having an assigned category linked with at least one other category, the search results being capable of representing different types of content;
provide for presentation of selected ones of the search results associated with corresponding selected categories in respective category result areas; and
provide for presentation of an advertisement result in a category result area of a corresponding category related to the advertisement result.
